(19) United States
(12) Patent Application Publication
(10) Pub. No.: US 2011/0234411 A1
(43) Pub. Date: Sep. 29, 2011

(54) Occupant Support System and Associated Method of Operation

(76) Inventors: John T. Harrington, Cary, NC (US); Christian Saucier, Raleigh, NC (US); Dan R. Tallent, Hope, IN (US)

(21) Appl. No.: 12/749,212

(22) Filed: Mar. 29, 2010

(51) Int. Cl. G08B 21/02

(52) U.S. Cl. 340/573.4

(57) ABSTRACT

An occupant support system 28 comprises a receiver 104 for receiving an order 106 from an information system 10 and a processor 102 capable of communication with the receiver and able to execute instructions in response to the order to change the state of the occupant support system and also able to issue a status message 112 to the information system to indicate the status of the state change. A method for operating an occupant support system includes receiving an order 106 from the information system 10, executing instructions in response to the order to change the state of the occupant support system, and issuing a status message 112 to the information system to indicate the status of the state change.

### TECHNICAL FIELD

The subject matter described herein relates to care delivery systems and associated methods of operation. One example application for the systems and methods is in the delivery of care to a patient occupying a bed in a hospital or other health care setting.

### BACKGROUND

Beds used in health care settings include a number of configurable components. These include elevation adjustable frames, inclination adjustable deck segments, stowable and deployable siderails, casters equipped with brakes, and on-board lights that can be switched on to illuminate the floor in the vicinity of the bed. Such beds might also include a patient position monitoring (PPM) system with specifiable sensitivity settings. Depending on the sensitivity setting, the PPM system issues an alarm when it detects conditions indicative of patient movement (high sensitivity setting), patient attempting to exit the bed (moderate sensitivity setting), and patient absent from the bed (low sensitivity setting). The PPM system can also be turned off.

The above described beds also include a mattress. One type of mattress is a pneumatic mattress having air bladders inflatable to an appropriate pressure for supporting an occupant. Alternatively the beds may be equipped with a non-pneumatic mattress, for example a foam mattress. The mattress can include an integral microclimate management (MCM) topper or be covered with a removable microclimate management topper. Such toppers typically include an air chamber, an air inlet for admitting air to the chamber, an air outlet remote from the inlet for exhausting air from the chamber, and numerous small discharge holes distributed over the occupant side of the topper. During operation, air flows from the inlet to the outlet by way of the chamber. A portion of the air flowing through the chamber discharges through the discharge holes. The flow of air through the chamber and the discharge of a portion of that air through the discharge holes helps enhance occupant comfort by controlling the temperature and humidity in the immediate vicinity of the occupant and removing perspiration. Such control of the microclimate can also guard against development of pressure ulcers on the occupant's skin.

The bed can also include an array of turn assist bladders. A typical turn assist bladder array includes laterally left and right bladders, each of which extends substantially longitudinally. Both bladders are normally deflated. When a caregiver needs to turn a patient, he inflates one of the bladders to assist with the labor of executing the turn. The turn assist bladders can also be used to provide lateral rotation therapy (LRT). Lateral rotation therapy involves cycling of the intrabladder pressure between lower and higher pressures to gently roll the bed occupant from side to side. LRT can be useful for keeping the occupant's lungs clear.

Beds also include capabilities for providing entertainment such as an on-board television or at least controls for a stand-alone television. Other capabilities include an on-board personal computer for allowing a occupant to continue with his professional or academic pursuits despite being temporarily confined to the bed or the care facility.

As is evident from the foregoing, the bed can be placed in various states corresponding to elevation, deck segment inclination, PPM status, on-board light status (e.g. on or off), MCM state, and turn assist bladder state, to name just a few. Setting of the states is sometimes best left to the discretion of the bed occupant or the attending, local caregiver. At other times it may be advisable to relieve the caregiver of the burden of setting specific states, especially when the requirement for those states has been established at an earlier time and/or by another person spatially remote from the bed and the patient. For example a facility admissions administrator might observe that the patient's medical history indicates that the patient is susceptible to falling, and therefore it would be appropriate for the patient's bed, which is in a different part of the facility and which the patient will not occupy until a later time, to be configured in a way that mitigates the patient's risk of falling. Similarly, a surgeon might order LRT to be applied beginning twelve hours after the patient's surgery has been completed.

### SUMMARY

The present application discloses an occupant support system capable of assuming at least two states and of communicating with an information system which has a memory and can be configured to convey information to and receive information from the occupant support system. The occupant support system comprises a receiver for receiving an order from the information system and a processor capable of communication with the receiver and able to execute instructions in response to the order to change the state of the occupant support system and also able to issue a status message to the information system to indicate the status of the state change. Also disclosed is a method for operating an occupant support system capable of assuming at least two states and of communicating with an information system which has a memory and which can be configured to convey information to and receive information from the occupant support system. The method includes receiving an order from the information system, executing instructions in response to the order to change the state of the occupant support system, and issuing a status message to the information system to indicate the status of the state change.

### BRIEF DESCRIPTION OF THE DRAWINGS

The foregoing and other features of the various embodiments of the system and method described herein will become more apparent from the following detailed description and the accompanying drawings in which:

FIG. 1 is a view depicting an information system having a memory for storing bed state requirements and also showing a schematic, left side elevation view of a bed, both the information system and bed being of a type that might be employed in a hospital or other health care setting.

FIG. 2 is a schematic view showing the memory of FIG. 1 and a bed control system capable of receiving an order from the information system directing the bed to assume a desired state and also capable of issuing a status message to the information system.

FIG. 3 is a flow diagram showing receipt of an order from the information system, execution of bed state change instructions in response to the order, and issuance of a status message to the information system.

FIG. 4 is a flow diagram similar to that of FIG. 3 showing an option for a caregiver to accept or decline the order.

FIG. 5 is a flow diagram similar to that of FIG. 4 showing an option for the caregiver to modify an order.

FIG. 6 is a flow diagram similar to that of FIG. 3 showing the information system carrying out an additional step of converting a requirement into a protocol.

FIG. 7 is a flow diagram similar to that of FIG. 5 showing the bed control system carrying out the additional step of converting the requirement into a protocol.

### DETAILED DESCRIPTION

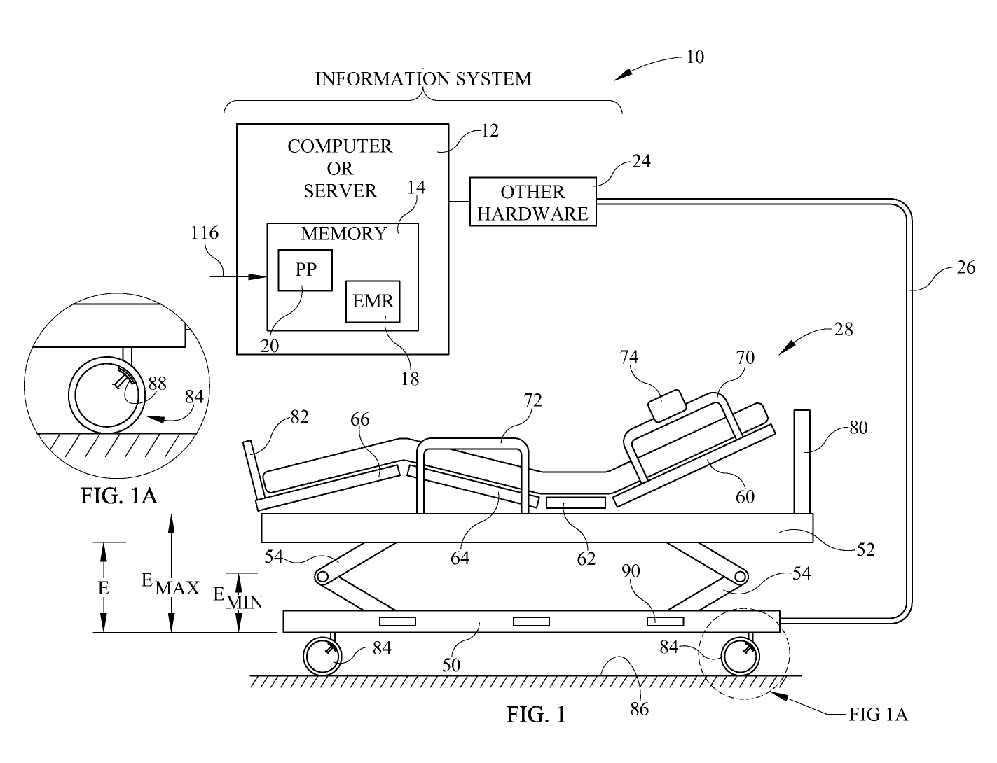

Referring to FIG. 1 an information system 10 of the type that might be found in a hospital or other health care facility includes a computer 12 having a memory 14. The memory includes information such as electronic medical records (EMR's) and patient specific patient profiles (PP's) which may be stand-alone data packages, as shown, or may be part of the a patient's EMR. Other system components 24 include those typically associated with communication networks, for example routers. The system may be wireless and/or may rely on physical pathways 26 such as wires or fiber optic cables to interconnect system components with each other and with components, such as an occupant support system exemplified by bed 28, that are not traditionally part of the information system.

Information system memory 14 receives user provided data as indicated at input arrow 116. The data is stored in various records. One example is the patient profile record PP that includes patient and family member identity information, residence address, and certain other patient specific details such as a notation that the patient is susceptible to falling and therefore the patient's bed should be configured in a way that mitigates the patient's risk of falling. Such a record might be maintained by an admissions administrator who is physically remote from the patient's assigned bed, temporally remote from the time when the patient will occupy the bed, and who is not the person directly responsible for placing the bed in the desired configuration. Another example is an electronic medical record (EMR). The EMR might be updated by a surgeon to prescribe, for example, LRT to be applied beginning twelve hours after completion of the patient's surgery. Once again, such a prescription would typically be entered into the EMR at a location remote from the patient's assigned bed, some significant period of time prior to scheduled commencement of the treatment, and by a person (a surgeon) other than the person (a nurse) who will be expected to initiate the therapy.

The information system conveys the information to the bed by way of communication path 26. The information conveyed can include orders for the bed to assume a particular state based on the data in the patient profile and/or the electronic medical record.

An occupant support system such as bed 28 includes a base frame 50 and an elevatable frame 52. A lift system represented by lift links 54 and associated actuators (not illustrated) renders the elevatable frame height adjustable to an elevation E relative to the base frame between a minimum elevation E_{MIN} and a maximum elevation E_{MAX}. The bed also includes a deck comprised of multiple sections or segments including upper body section 60, seat section 62, thigh section 64 and calf section 66. Sections 60, 62, and 66 are inclination adjustable. Left and right side head end siderails 70, only the left one of which is visible, are secured to the upper body deck section. Left and right side foot end siderails 72, only the left one of which is visible, are secured to the elevatable frame. The siderails can be placed in at least a raised or deployed position and a lowered or stowed position. A user interface 74 is provided to control bed functions. A typical user interface is a bed mounted unit comprised of a keypad having user operable keys for accepting user inputs and also having a display for conveying information to the user. Other types of interfaces, such as pendants, may be provided as an auxiliary way to control the bed functions and/or functions of other devices such as a television.

The bed also includes a headboard 80 extending from the base frame and a footboard 82 mounted on calf deck section 66. Casters 84 extend from base frame 50 to the floor 86. The casters are equipped with parking brakes 88 represented in the illustration as a brake shoe. Night lights 90 are mounted on the base frame to provide soft illumination for an occupant who needs to leave the bed after dark. The bed also includes load cells, not shown, that are part of a scale or other weight sensing system for monitoring occupant weight and for informing a PPM system of occupant presence and position. The bed may also have a microclimate management (MCM) system.

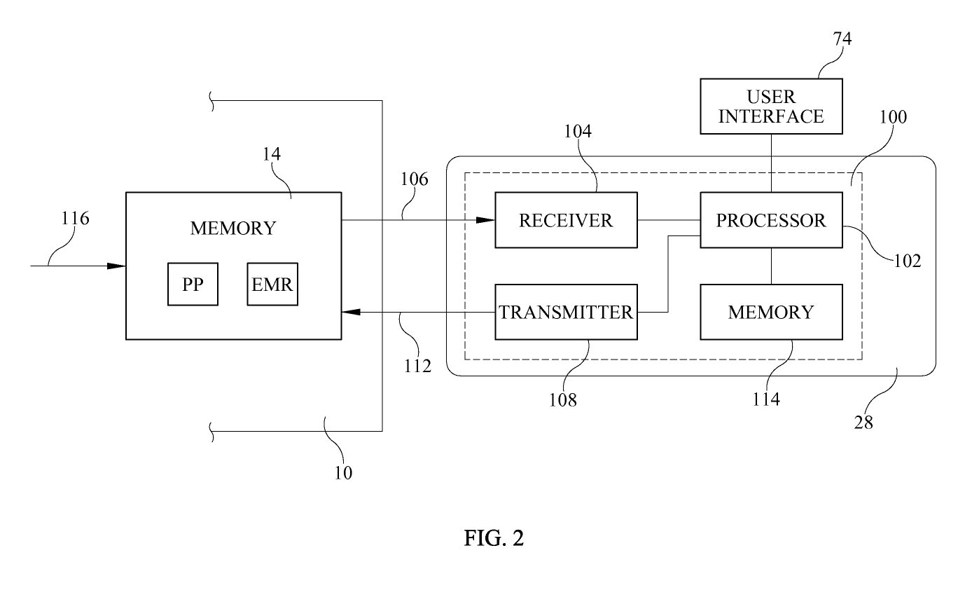

Referring additionally to FIG. 2, the bed also includes a control system 100 which includes a processor 102, (which may be an array of processors) a receiver 104 capable of communicating with the processor and capable of receiving information 106 from the information system, a transmitter 108 capable of communicating with the processor and capable of conveying information 112 to the information system, and a memory 114 containing information, such as instructions executable by the processor. Although the receiver and transmitter are shown as separate components, they may be combined into a transceiver unit.

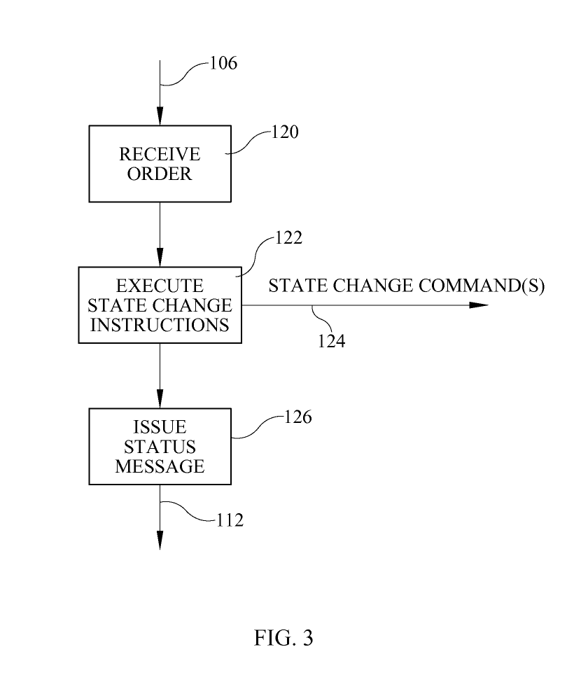

Referring additionally to FIG. 3 receiver 104 on the bed receives the order 106 from the information system 10 at block 120. In response to receipt of the order the processor executes appropriate instructions (block 122) stored in memory 114 to cause a state change command or commands 124 to be issued to the bed components involved in effecting the state change. One example state change command is a command for one or more actuators to operate to change the elevation E of the elevatable frame. Another example is a set of commands to raise at least the head end siderails, apply the parking brake, turn on the PPM system and set it to its moderately sensitive state, all in response to an indication that the occupant of the bed has been identified as being susceptible to falling. Another example is a command or set of commands to operate compressors, blowers, valves and other hardware in such a way to deliver lateral rotation therapy or operate the microclimate management system. At block 126 the bed issues a status message 112 to the information system to indicate the status of the state change. The status message may be a function of information received from various feedback sensors located on the bed, for example a position sensor indicating the elevation E of elevatable frame 52.

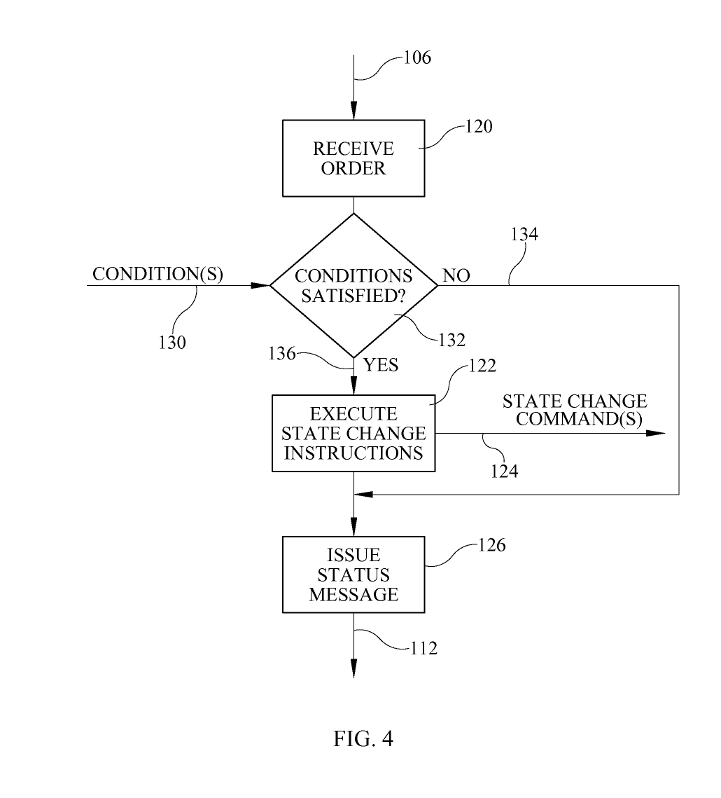

FIG. 4 shows a variation in which the instructions to cause a state change are conditionally executed, i.e. executed only if one or more order acceptance conditions 130 has been satisfied. One example of an order acceptance criterion that could be tested by a logical test at block 132 is whether or not an occupant is on the bed. One way to assess bed occupancy is by monitoring the output of the scale or other weight sensing system. If an occupant is not on the bed (i.e. if the condition is not satisfied), the method proceeds along “NO” branch 134, the practical effect of which is to decline to accept the order. If an occupant is on the bed (i.e. the condition is satisfied), the method proceeds along “YES” branch 136 thereby causing execution of the state change instructions. No caregiver intervention is required because the logic 132 can interrogate the output of the scale to determine if an occupant is on the bed.

Alternatively, the condition 132 to be satisfied can be (or can include) one that requires caregiver intervention. For example, caregivers at some facilities might have the discretion to disregard or modify an order to put the bed in a specific fall risk mitigation state based on their evaluation of the patient and the patient's needs. The condition 132 to be satisfied would be the caregiver's acceptance of the order. In practice, the user interface 74 would offer the caregiver an option to accept or decline the order. The method proceeds along branch 134 if the caregiver declines the order (or if other, non-discretionary conditions are not satisfied) or along branch 136 if the caregiver accepts the order (and any non-discretionary conditions are also satisfied).

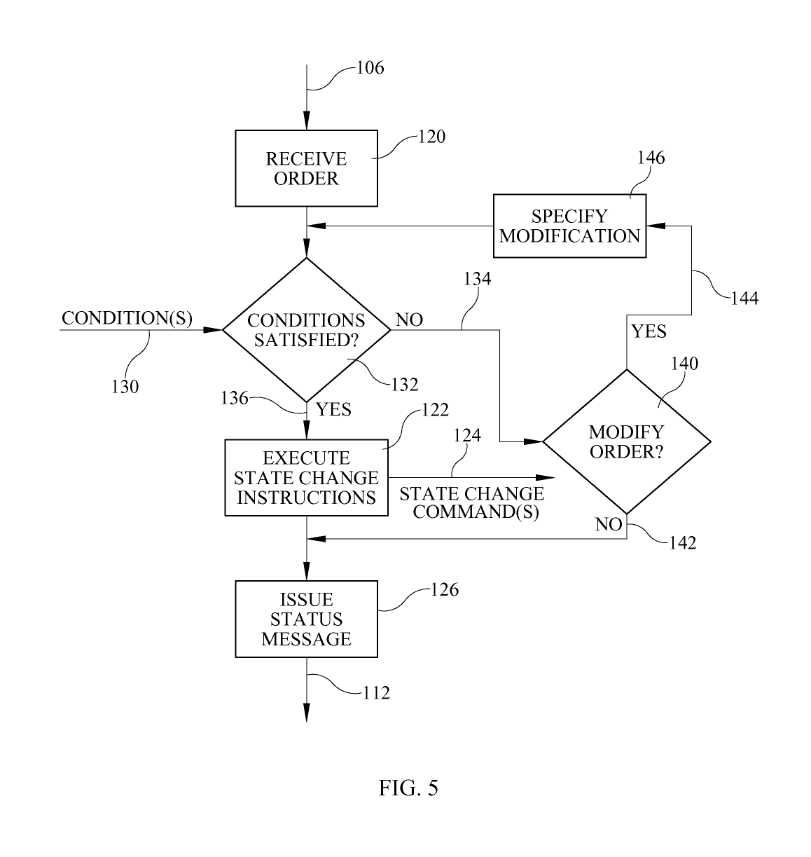

FIG. 5 shows a further variation of the method. If the caregiver declines the order at block 132, the method offers an invitation at block 140 to modify the order. If the caregiver accepts the invitation the method proceeds along “YES” branch 144 to block 146 where the caregiver specifies the desired modification. The method then proceeds again to conditional test block 132 to test whether any non-discretionary conditions are still satisfied. If the caregiver declines the invitation at block 140 the method proceeds along “NO” branch 142. For example a caregiver may use the user interface 74 to decline an order at 132 to place the bed in a fall risk mitigation state in which the PPM system is set at a moderate sensitivity setting, but specify a modified order at block 146 calling for a high sensitivity setting.

Irrespective of which branch or branches the method follows, the method issues a status message 112 at block 126 to indicate the status of the ordered state change. Examples of status messages that could be reported include: COMPLETE (the order has been complied with) PENDING (the order has been received but actions to comply with the order have not yet begun) IN PROGRESS (actions to comply with the order have begun but have not yet been completed) INTERRUPTED (actions to comply with the order began but ceased prematurely) and DECLINED (the order has not been accepted). In the case of a modified order the modification itself is also reported to the information system.

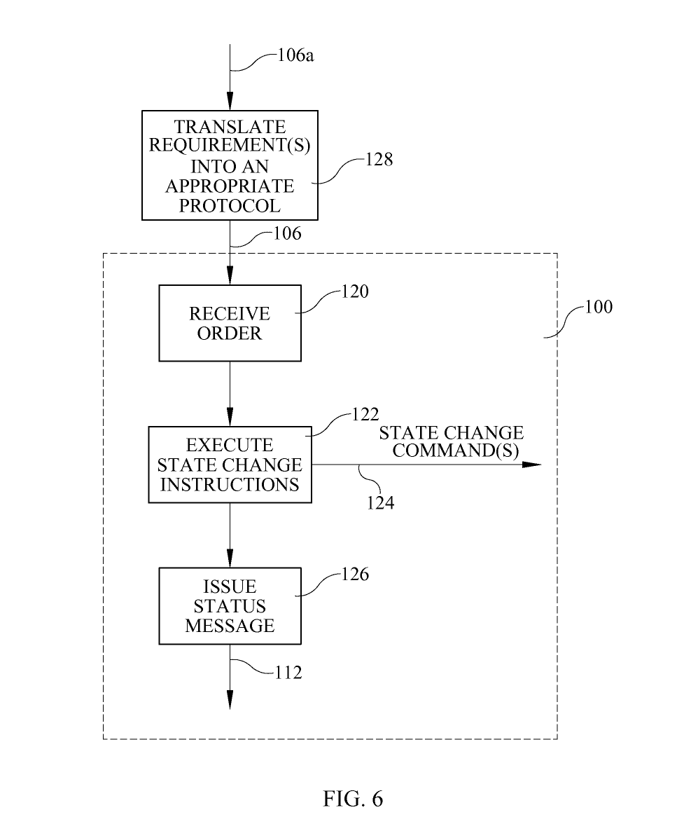

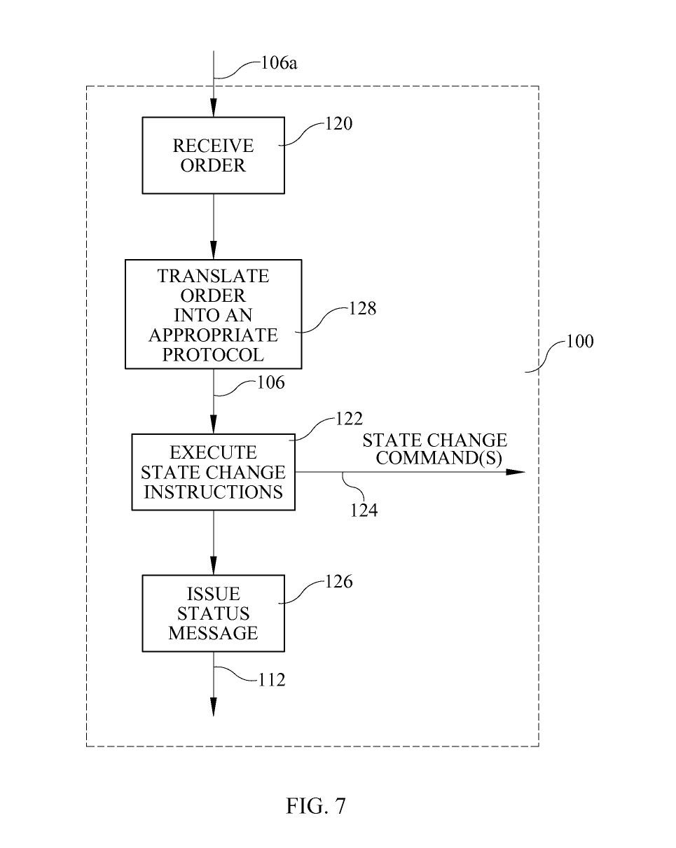

Certain bed configuration requirements residing in the information system memory may be in the form of primitive orders that must be converted into an associated, actionable protocol before the requirement can be acted upon. One example of a primitive order is a notation or prescription in the information system that the bed should be in a state that mitigates fall risk. The corresponding actionable protocol, which is typically defined by the managers of the health care facility, might specify that the fall risk mitigation state is one in which the elevating frame is at its lowest possible elevation relative to the base frame, the brakes are applied, all four siderails are deployed, and the PPM system is turned on and set to its most sensitive level. Alternatively, the fall risk mitigation protocol might specify a state in which the elevatable frame is at its lowest possible elevation relative to the base frame, the brakes are applied, at least the head end siderails are deployed, and the PPM system is turned on and set to its moderate sensitivity level. In the case of a primitive order to apply LRT to the patient, the corresponding actionable protocol might specify the pressure amplitude and cycle frequency. FIG. 6 includes a block 128 at which the bed information system converts a primitive order 106a into an actionable protocol representing the order or orders 106 to be complied with, and conveys the actionable order 106 to the bed. FIG. 7 is a similar method in which the receiver 104 on the bed receives the primitive order 106a at block 120 and in which the processor 102 carriers out the conversion. It should be noted that the variations of the method shown in FIGS. 6 and 7 can be used with or without the conditional logic 132 of FIGS. 4 and 5.

The information system memory 14 may contain various classes of bed state requirements. One class is a patient care related class which is segregated into two subclasses: a therapeutic/preventive subclass and a non-therapeutic class. Example requirements in the therapeutic/preventive subclass include:
a) a lateral rotation therapy requirement;
b) a percussive therapy requirement;
c) a deep vein thrombosis preventive therapy requirement;
d) a ventilator acquired pneumonia preventive therapy requirement; and
e) a pressure ulcer risk accommodation requirement.

Example requirements in the non-therapeutic sub-class include
a) a fall risk mitigation requirement and
b) a requirement to power the night lights.

Another class of requirements is non-care related requirements. One example is a requirement to disable entertainment controls, e.g. after 9:00 pm.

It should be appreciated, however, that classification of requirements is, at least to some degree, a matter of discretion. For example the fall risk mitigation requirement could easily fall under the therapeutic/preventive classification.

Although this disclosure refers to specific embodiments, it will be understood by those skilled in the art that various changes in form and detail may be made without departing from the subject matter set forth in the accompanying claims.

We claim:

1. An occupant support system capable of assuming at least two states and of communicating with an information system, the information system having a memory and being configured to convey information to and receive information from the occupant support system, the occupant support system comprising:
a receiver for receiving an order from the information system;
a processor capable of communication with the receiver and able to execute instructions in response to the order to change the state of the occupant support system and also able to issue a status message to the information system to indicate the status of the state change.

2. The occupant support system of claim 1 wherein the processor conditionally executes the instructions.

3. The occupant support system of claim 1 wherein the condition for executing the instructions is perceived presence of an occupant on the occupant support system.

4. The occupant support system of claim 1 wherein the condition for executing the instructions is user acceptance of the order.

5. The occupant support system of claim 4 wherein a user interface associated with the occupant support system allows a user to accept or decline the order.

6. The occupant support system of claim 4 wherein declining the order allows the user to issue an alternative order.

7. The occupant support system of claim 1 wherein the order is a function of a profile of an occupant stored in the information system memory.

8. The occupant support system of claim 1 wherein the order is an occupant care related requirement.

9. The occupant support system of claim 1 wherein the order is a non-care related requirement.

10. A method for operating an occupant support system capable of assuming at least two states and of communicating with an information system, the information system having a memory and being configured to convey information to and receive information from the occupant support system, the method comprising:
receiving an order from the information system;
executing instructions in response to the order to change the state of the occupant support system; and
issuing a status message to the information system to indicate the status of the state change.

11. The method of claim 10 wherein the instructions are conditionally executed.

12. The method of claim 10 wherein the condition for executing the instructions is perceived presence of an occupant on the occupant support system.

13. The method of claim 10 wherein the condition for executing the instructions is user acceptance of the order.

14. The method of claim 13 wherein a user interface associated with the occupant support system allows a user to accept or decline the order.

15. The method of claim 13 wherein declining the order allows the user to issue an alternative order.

16. The method of claim 10 wherein the order is a function of a profile of a occupant support system occupant stored in the information system memory.

17. The method of claim 10 wherein the order is an occupant care related requirement.

18. The method of claim 10 wherein the order is a non-care related requirement.
